(19) United States
(12) Patent Application Publication
(10) Pub. No.: US 2025/0189383 A1
(43) Pub. Date: Jun. 12, 2025

(54) SEMICONDUCTOR STRUCTURE HAVING THERMAL SENSOR AND MANUFACTURING METHOD THEREOF

(71) Applicant: Taiwan Semiconductor Manufacturing Company, Ltd., Hsinchu (TW)

(72) Inventors: Sam Vaziri, San Jose, CA (US); Jiadi Zhu, Hsinchu (TW); Isha Datye, Hsinchu (TW); Xinyu BAO, Fremont, CA (US)

(73) Assignee: Taiwan Semiconductor Manufacturing Company, Ltd., Hsinchu (TW)

(21) Appl. No.: 18/533,089

(22) Filed: Dec. 7, 2023

(51) Int. Cl. G01K 7/34; G01K 7/01; G01K 13/00

(52) U.S. Cl. CPC G01K 7/34; G01K 7/015; G01K 13/00

(57) ABSTRACT

A semiconductor structure includes a first interconnect structure disposed over a first semiconductor substrate and a thermal sensing device. The thermal sensing device includes a first transistor, a second transistor, a first capacitor coupled to the first transistor, a second capacitor coupled to the second transistor, and a metallization pattern embedded in the first interconnect structure and serving as a resistive heater. At least one selected from the group of the first and second transistors is embedded in the first interconnect structure.

### BACKGROUND

The semiconductor industry has experienced rapid growth due to continuous improvement in integration density of various devices. For the most part, this improvement in integration density has come from successive reductions in minimum feature size, which allows more devices to be integrated into a given area. Technological advances in integrated circuit (IC) design have produced generations of ICs where each generation has smaller and more complex circuit designs than the previous generation. The high device density may introduce heat that may cause performance deterioration. To monitor and control heat generation, thermal sensors may be needed. Although existing semiconductor structures with thermal sensors are generally adequate for their intended purposes, they are not satisfactory in all aspects.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1, 2A, 3A, and 4-7 illustrate schematic cross-sectional views of intermediate stages in the manufacturing of a semiconductor structure having thermal sensors, in accordance with some embodiments.

FIG. 2B and FIG. 3B illustrate schematic cross-sectional views of variations of the structures shown in FIG. 2A and FIG. 3A, respectively, in accordance with some embodiments.

FIG. 8 illustrates a schematic cross-sectional view of a semiconductor structure, in accordance with some embodiments.

FIG. 9 illustrates a schematic circuit diagram of a measurement circuit for a thermal sensor, in accordance with some embodiments.

FIG. 10A illustrates a schematic top-down view of a layer of the interconnect structure in which the thermal sensors are located, in accordance with some embodiments.

FIG. 10B illustrates a schematic cross-sectional view of a portion of the thermal sensors in the interconnect structure, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The high device density brought about by advanced transistors may introduce heat, and accumulation of heat in a semiconductor structure may cause performance deterioration. Embodiments discussed herein are to provide a semiconductor structure including thermal sensor(s), where the thermal sensor(s) may be configured to monitor temperature of the hot spots on-chip and in real time and create 2D/3D temperature profile mapping of the semiconductor structure. The thermal sensor(s) may be fabricated by Front-end-of-line (FEOL) process and/or back-end-of-line (BEOL) processes, and may be formed of materials which are compatible with FEOL and/or BEOL processes. It should be noted that throughout the description, the terms “thermal sensor” and “thermal sensing device” are interchangeably used.

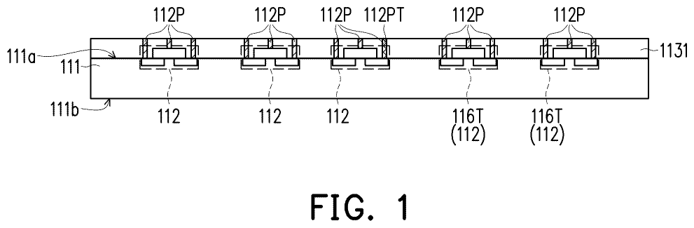

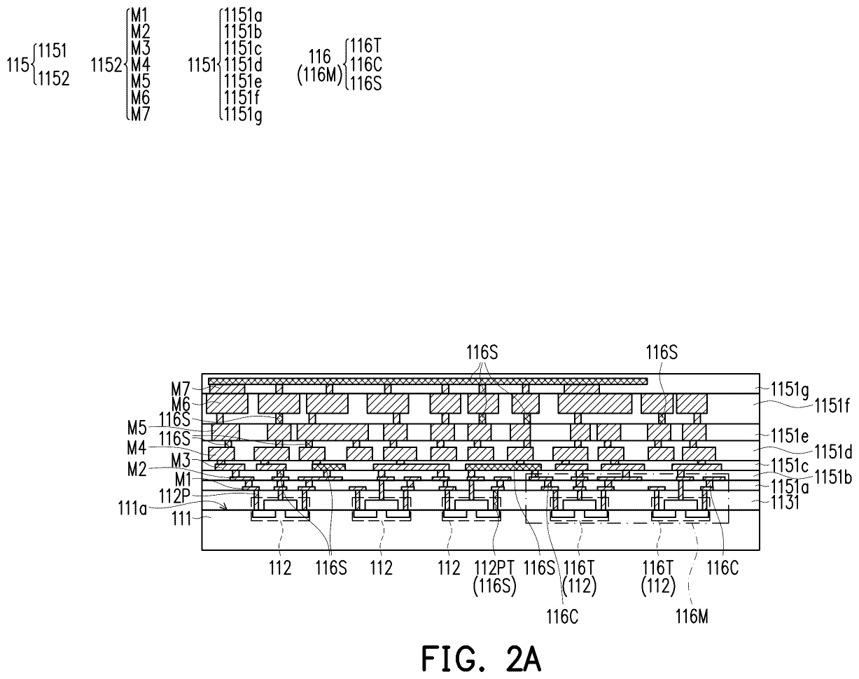

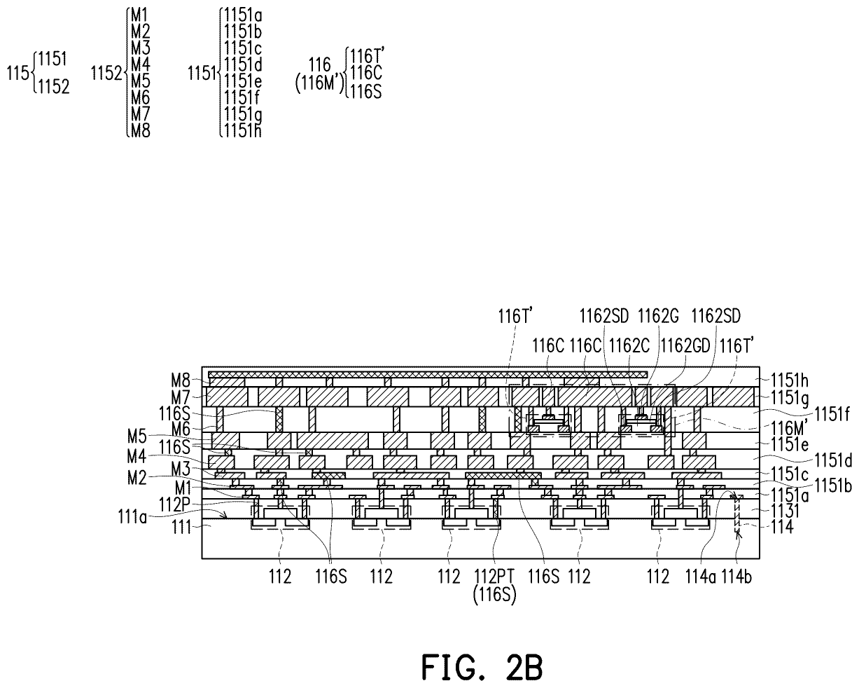

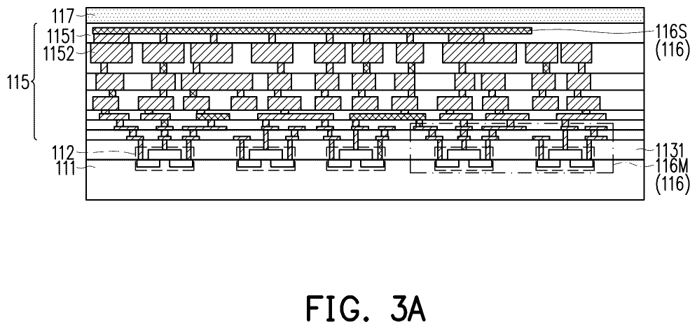

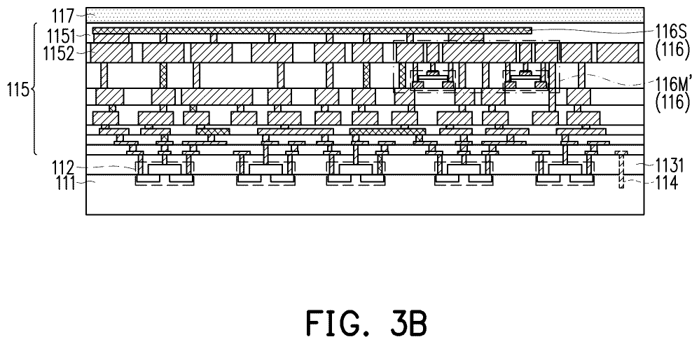

FIGS. 1, 2A, 3A, and 4-7 illustrate schematic cross-sectional views of intermediate stages in the manufacturing of a semiconductor structure having thermal sensors, in accordance with some embodiments. FIG. 2B and FIG. 3B illustrate schematic cross-sectional views of variations of the structures shown in FIG. 2A and FIG. 3A, respectively, in accordance with some embodiments. The manufacturing method described below is merely an example and is not intended to limit the present disclosure. Additional steps may be provided before, during and after the manufacturing method and some steps described can be replaced, eliminated, or moved around for additional embodiments of the method. Not all steps are described herein in detail for reasons of simplicity. Additionally, throughout the descriptions and across different embodiments, like reference numerals denote like features with similar structures and compositions, unless otherwise excepted.

Referring to FIG. 1, a semiconductor substrate 111 is provided. For example, the semiconductor substrate 111 is in a wafer form, a chip form, a panel form, etc. The semiconductor substrate 111 may include a front side 111a (or an active surface) and a back side 111b opposite to the front side 111a. The semiconductor substrate 111 may include one or more semiconductor material(s), such as silicon; germanium; a compound semiconductor including silicon carbide, gallium arsenic, gallium phosphide, indium phosphide, indium arsenide, and/or indium antimonide; an alloy semiconductor including SiGe, GaAsP, AlInAs, AlGaAs, GaInAs, GaInP, and/or GaInAsP; or combinations thereof. Other substrates, such as multi-layered or gradient substrates, may also be used.

In some embodiments, one or more device(s) 112 may be formed at the front side 111a of the semiconductor substrate 111. The device(s) 112 may be active devices (e.g., transistors, diodes, etc.), passive devices (e.g., capacitors, resistors, inductors, etc.), combinations thereof, and/or the like. The devices 112 may be or include high-power device(s) and/or low-power device(s). It should be appreciated that although the devices 112 are represented by a transistor, the devices 112 may have a different number and type than shown. In some embodiments, the devices 112 are formed using suitable FEOL process and may be referred to as the FEOL devices 112. In some embodiments, a portion of the devices 112 (e.g., FEOL devices 116T) is included in a measurement circuit (e.g., 116M labeled in FIG. 2A) applied in the thermal sensing device. In some embodiments, the FEOL devices 116T are included in a control circuit of the thermal sensing device for dynamically control the temperature across the semiconductor structure. In alternative embodiments, none of the FEOL devices is included in the thermal sensing device, where the transistors of the thermal sensing device are formed through the subsequently-performed BEOL processes.

With continued reference to FIG. 1, an inter-layer dielectric (ILD) layer 1131 is formed over the front side 111a of the semiconductor substrate 111 to surround and cover the devices 112. The ILD layer 1131 may include one or more dielectric material(s) such as phospho-silicate glass (PSG), boro-silicate glass (BSG), boron-doped phospho-silicate glass (BPSG), undoped silicate glass (USG), the like, or combinations thereof. In some embodiments, conductive plugs 112P are formed and extend through the ILD layer 1131 to electrically and physically couple to the devices 112. The conductive plugs 112P may be formed of W, Co, Ni, Cu, Ag, Au, Al, alloy, the like, or combinations thereof, and may be formed through middle-end-of-line (MEOL) processes. For example, when the devices 112 are transistors, the conductive plugs 112P may couple the gates and source/drain (S/D) regions of the transistors. It should be noted that S/D region(s) may refer to a source or a drain, individually or collectively dependent upon the context. Although shown as being formed in the same cross-section, it should be appreciated that each of the conductive plugs 112P coupled to the gates and S/D regions may be formed in different cross-sections, which may avoid shorting of the contacts. In some embodiments, a portion of the conductive plugs 112P (e.g., 112PT) is included in the thermal sensing device which will be described later in more detail. Alternatively, none of the conductive plugs 112P is included in the thermal sensing device.

Referring to FIG. 2A and with reference to FIG. 1, an interconnect structure 115 may be formed over the front side 111a of the semiconductor substrate 111. For example, the interconnect structure 115 is formed on the ILD layer 1131 and the conductive plugs 112P through BEOL processes. In some embodiments, the interconnect structure 115 includes one or more dielectric layer(s) 1151 and one or more conductive layer(s) 1152 covered by the dielectric layer 1151. The dielectric layer(s) 1151 may include one or more dielectric material(s) such as low-k dielectric materials (e.g., PSG, BPSG, Spin-On-Glass (SOG), silicon carbon materials, combinations thereof, etc.) or any suitable dielectric materials. The dielectric layer(s) 1151 may be referred to as an inter-metal dielectric (IMD) layer. For example, the dielectric layer 1151 includes a plurality of dielectric sublayers (e.g., 1151a, 1151b, 1151c, 1151d, 1151e, 1151f, and 1151g) which may have the same material or include different materials. It should be appreciated that although seven dielectric sublayers are shown, the dielectric layer 1151 may include more than seven dielectric sublayers or less than seven dielectric sublayers, depending on circuit and product requirements.

The conductive layer(s) 1152 may electrically interconnect the devices 112 through the conductive plugs 112P to form functional circuitry. The conductive layer(s) 1152 may include one or more conductive material(s) such as Ti, Cu, Ni, Ag, Au, Al, alloy, the like, or combinations thereof. In some embodiments, the conductive layer 1152 includes a plurality of conductive sublayers (e.g., M1, M2, M3, M4, M5, M6, and M7) which may be formed of the same material or include different materials. For example, each of the conductive sublayers is embedded in corresponding one of the dielectric sublayers. In some embodiments, each conductive sublayer includes conductive lines, conductive vias, conductive pads, a combination thereof, etc. The conductive vias in the conductive layer 1152 may go through the plane of adjacent sublayers and provide electrical connection between the adjacent sublayers. In some embodiments, the dimension and line/spacing of the upper conductive sublayer are greater than the dimension and line/spacing of the lower conductive sublayer. It should be appreciated that although seven conductive sublayers are shown, the conductive layer 1152 may include more than seven conductive sublayers or less than seven conductive sublayers, depending on circuit and product requirements.

With continued reference to FIG. 2A, one or more thermal sensing device(s) 116, also called thermal/temperature sensor, may be embedded in the interconnect structure 115. The thermal sensing device 116 may (or may not) be electrically isolated from the conductive layer 1152 in the functional circuits of the resulting semiconductor structure. In some embodiments, materials and forming methods of the thermal sensing device(s) 116 are compatible with BEOL/MEOL/FEOL processes. For example, a portion of the thermal sensing device(s) 116 embedded in the interconnect structure 115 is built by the BEOL processes, a portion of the thermal sensing device(s) 116 embedded in the ILD layer 1131 is built by the MEOL processes, and/or a portion of the thermal sensing device(s) 116 formed at the front side 111a of the semiconductor substrate 111 is built by the FEOL processes.

In some embodiments, the respective thermal sensing device 116 includes one or more FEOL devices(s) 116T and one or more BEOL device(s) 116C connected to the FEOL devices 116T. For example, the FEOL devices 116T are implemented by FEOL transistors 116T and may be formed at the same level height as the devices 112. The BEOL devices 116C may be implemented by capacitive elements (or capacitors) 116C. For example, the FEOL devices 116T and the BEOL devices 116C are included in a measurement circuit 116M of the thermal sensing device 116. In some embodiments, the respective thermal sensing device 116 includes one or more metallization pattern(s) 116S. In some embodiments, the metallization patterns 116S are formed of one or more conductive material(s) which are BEOL-compatible materials, and may be formed by BEOL-compatible processes. The material(s) of the metallization patterns 116S may include W, Ru, TiN, TaN, a combination thereof, the like, etc. In some embodiments, a portion (e.g., 112PT) of the metallization patterns 116S is formed in the ILD layer 1131. For example, the portion (e.g., 112PT) of the metallization patterns 116S includes MEOL-compatible materials, and may be formed by MEOL-compatible processes. The temperature coefficient of resistance (TCR) for the circuit is determined by measuring the resistances over a temperature range. The metallization patterns 116S may provide a known TCR.

In some embodiments, the metallization patterns 116S serve as a heater and at the same time as a sensing element of thermal sensor. For example, the metallization patterns 116S serve as a resistive heater (or a resistive component). As the resistance of the metallization pattern 116S varies linearly with temperature, its temperature over length and thickness may be measured through the measurement of voltage between its two ends. In some embodiments, the metallization patterns 116S are connected to the FEOL devices 116T. The metallization patterns 116S may be formed in some of the dielectric sublayers of the dielectric layer 1151. For example, the metallization patterns 116S are formed in/above the dielectric sublayer 1151d (e.g., at the same level height as the conductive sublayer M4 and above the conductive sublayer M4), where the metallization patterns 116S may not be formed below the dielectric sublayers 1151d. In some embodiments, the metallization patterns 116S are formed in each of the dielectric sublayers of the dielectric layer 1151.

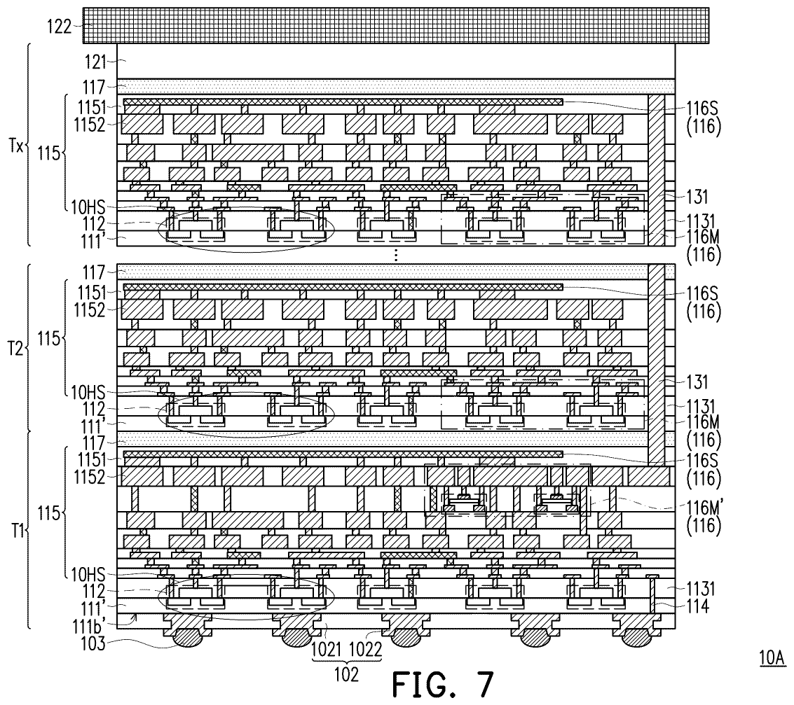

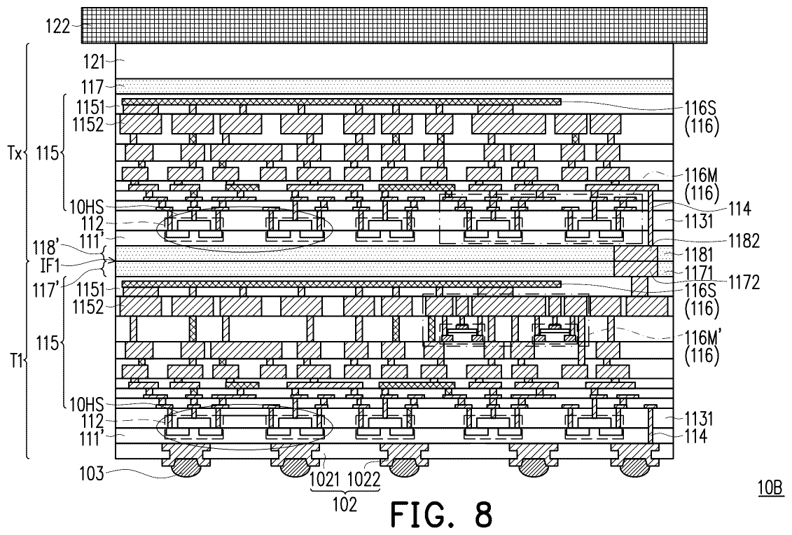

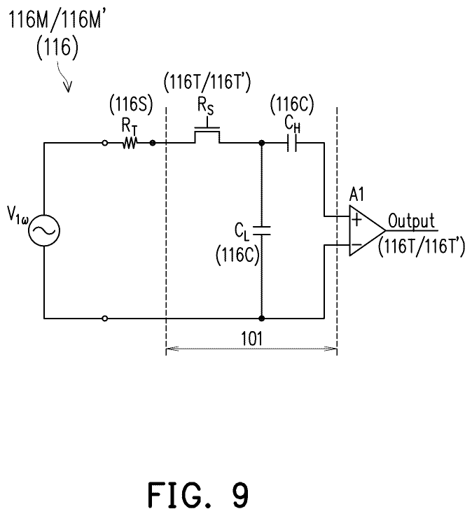

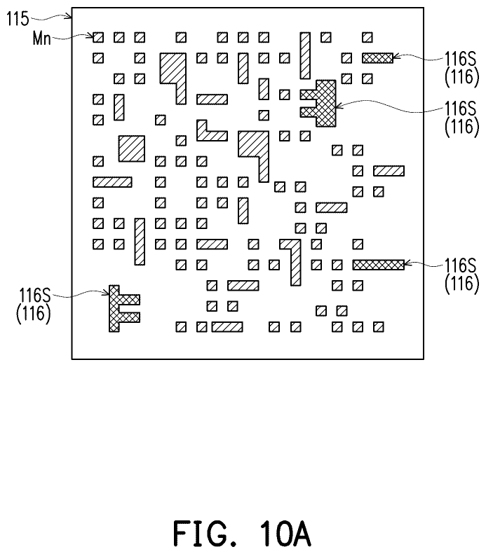

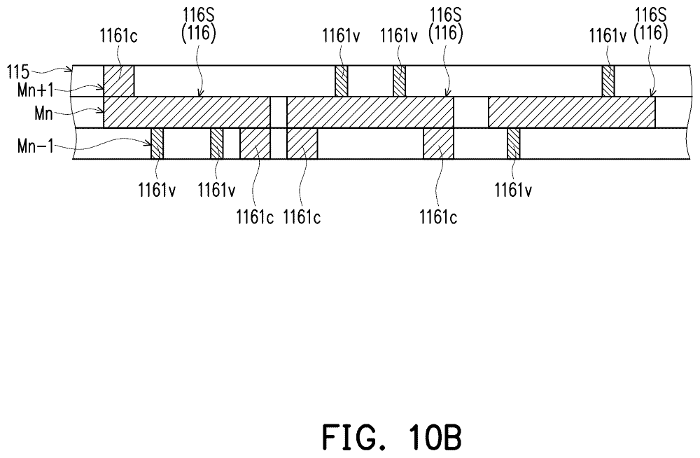

In some embodiments, a portion of the metallization patterns 116S is formed in the topmost one of the dielectric sublayers (e.g., 1151g) of the dielectric layer 1151 which is closest to the subsequently-formed bonding layer (e.g., 117 in FIG. 3A). In some embodiments, the metallization patterns 116S are distributed in proximity to a region having a sharp local temperature peak (referred to as a hot spot 10HS labeled in FIGS. 7-8) or any region/path having higher thermal bottleneck which needs heater control. The region/path having thermal bottleneck may be the device/region/path where heat flow is more restricted than other device/region/path in the resulting semiconductor structure. In some embodiments, the metallization patterns 116S are distributed in a denser manner near the region where the high-power devices are located, and the metallization patterns 116S are distributed in a sparser manner near the region where the low-power devices are located. The aforementioned devices to implement the metallization patterns 116S, the FEOL devices 116T, and the BEOL devices 116C are given for illustrative purposes. Various types of the sensing elements, the FEOL devices, and the BEOL devices are within the contemplated scope of the present disclosure. The metallization patterns 116S, the FEOL devices 116T, and the BEOL devices 116C will be described in more detail with reference to FIGS. 9 and 10A-10B.

Referring to FIG. 2B and with reference to FIG. 2A, the structure shown in FIG. 2B and the structure shown in FIG. 2A are similar, and thus detailed descriptions are not repeated. The difference therebetween includes that the conductive layer 1152 includes additional conductive sublayer M8 and the dielectric layer 1151 includes additional dielectric sublayer 1151h. Although eight dielectric sublayers and eight conductive sublayers are shown, the interconnect structure 115 may include more than different number of dielectric sublayers and conductive sublayers, depending on circuit and product requirements. One or more metallization pattern(s) 116S of the thermal sensing device 116 severing as a heater may be embedded in the dielectric sublayer 1151h. In some embodiments, the metallization pattern 116S formed in the dielectric sublayer 1151h is closest to the subsequently-formed bonding layer (e.g., 117 labeled in FIG. 3B).

In some embodiments, the FEOL devices 116T are replaced with the BEOL devices 116T′ and the capacitive elements 116C are connected to the BEOL devices 116T. For example, the respective BEOL device 116T′ is surrounded and covered by the dielectric layer 1151. The BEOL devices 116C may be disposed on and connected to the BEOL devices 116T′. In some embodiments, the BEOL devices (116T′ and 116C) are included in a measurement circuit 116M′ of the thermal sensing device 116. The BEOL devices 116T′ may be implemented by transistors. In some embodiments, the BEOL devices 116T′ are used in the thermal sensor by using the transistor's temperature-varying threshold voltage. The BEOL devices 116T′ may be formed of BEOL-compatible materials and formed by BEOL-compatible processes. The BEOL-compatible materials may include metal oxides, poly-Si, two-dimensional (2D) materials, carbon nanotubes (CNTs), III-V semiconductor materials, etc.

In some embodiments, the respective BEOL device 116T′ includes a gate electrode 1162G, S/D contacts 1162SD, a channel layer 1162C disposed below the gate electrode 1162G and laterally between the S/D contacts 1162SD, and a gate dielectric layer 1162GD vertically interposed between the gate electrode 1162G and the channel layer 1162C. For example, a material of the channel layer 1162C includes metal oxide (e.g., IGZO, In₂O₃, InWO, SnO, TaSnO, TiSnO, etc.), poly-Si, 2D material (e.g., MoS₂, WS₂, MoSe₂, WSe₂, MoTe₂, etc.), or any suitable channel material which is compatible with BEOL processes. In some embodiments where the BEOL devices 116T′ are 2D material-based transistors, the channel layer 1162C is formed of one or more 2D material(s) and may be deposited by metal-organic chemical vapor deposition (MOCVD) at low temperature (e.g., less than 400° C. or the like). In some embodiments, the channel layer 1162C is formed of one or more metal oxide material(s) and/or poly-Si, and may be deposited by sputtering or any suitable deposition process. The gate electrode 1162G and the S/D contacts 1162SD may include one or more conductive material(s). In some embodiments, the gate electrode 1162G and the S/D contacts 1162SD are formed by sputtering or any suitable deposition process. It should be noted that the BEOL devices 116T′ may have a different number and type than shown. In some embodiments, a combination of the FEOL device 116T (shown in FIG. 2A) and the BEOL device 116T′ is included in the measurement circuit 116M/116M′.

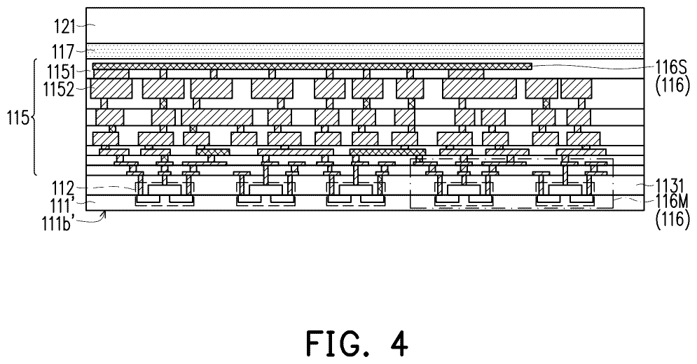

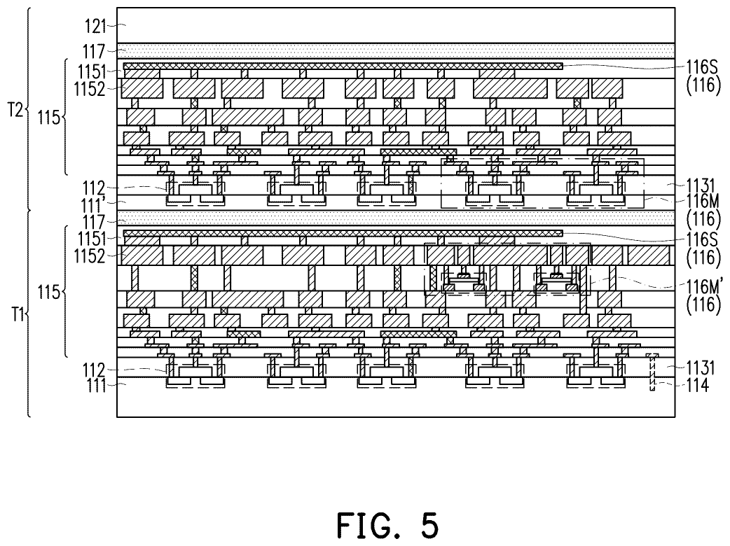

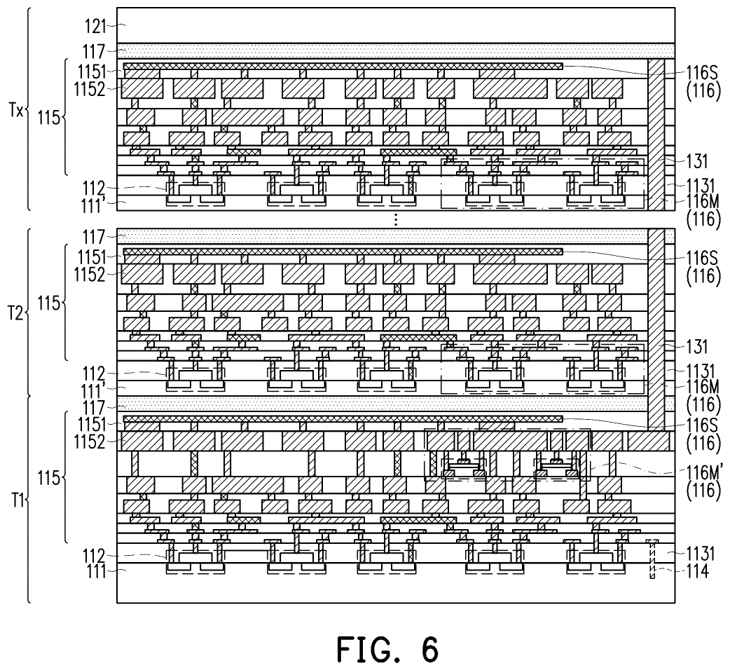

In some embodiments, one or more through via(s) 114 may be formed in the semiconductor substrate 111 and pass through the ILD layer 1131. For example, the through via 114 is formed by depositing one or more diffusion barrier layer(s) or isolation layer(s), depositing a seed layer, and depositing a conductive material (e.g., W, Ti, Al, Cu, any combinations thereof, and/or the like) into the trench of the ILD layer 1131 and the underlying semiconductor substrate 111. For example, the through via 114 includes a first end 114a substantially leveled with the ILD layer 1131 and a second end 114b opposite to the first end 114a, where the second end 114b may be buried in the semiconductor substrate 111 at this stage. It should be noted that although the through via 114 is illustrated in FIG. 2B, the through via 114 may be disposed in the structure shown in FIG. 2A through the same way. Alternatively, the through via 114 is omitted or may be formed in the subsequent steps (e.g., after the backside thinning process of FIG. 4 or after the bonding process of FIGS. 5-6); therefore, the through via 114 is illustrated in dashed lines to indicate it may or may not be present.

Referring to FIGS. 3A-3B and with reference to FIGS. 2A-2B, a bonding layer 117 may be formed on the interconnect structure 115. The bonding layer 117 may be or include one or more dielectric material(s) such as silicon oxide, silicon nitride, silicon oxynitride, silicon carbonitride, silicon oxy-carbonitride, or a combination thereof. The dielectric material of the bonding layer 117 may be formed by suitable fabrication techniques such as spin-on coating, CVD, ALD, PVD, or the like. In some embodiments, the bonding layer 117 includes bonding feature (not individually shown, but similar to the bonding feature 1172 described in FIG. 8) formed of conductive materials and electrically connected to the underlying conductive layer 1152. In some other embodiments, the bonding layer 117 is free of conductive features. In some embodiments, the aforementioned steps described in FIGS. 1, 2A, and 3A (or FIGS. 1, 2B, and 3B) may be repeated to form a plurality of tiers to be bonded.

Referring to FIG. 4 and with reference to FIG. 3A, a carrier 121 may be disposed on the bonding layer 117. In some embodiments, the carrier 121 provides mechanical and structural support in the resulting semiconductor structure. The carrier 121 may include any suitable material that is rigid enough to provide support for the underlying structure. For example, the carrier 121 includes silicon (e.g., bulk silicon), metal (e.g., steel), glass, ceramic, combinations thereof, multi-layers thereof, or the like. In some embodiments, the carrier 121 is a temporary carrier that is used to support the underlying structure during processing (e.g., a thinning process, a bonding process, a singulation process, etc.), and the temporary carrier may be removed once the processes are finished. In some embodiments, the carrier 121 includes one or more thermally conductive material(s) for facilitating thermal dissipation from the underlying structure to the external component or the overlying structure (if present).

In some embodiments, a thinning process (e.g., grinding, CMP, etching, a combination thereof, etc.) is performed on the back side of the semiconductor substrate 111 to form a semiconductor substrate 111′ having a back side 111b′. The bonding of the carrier 121 may be performed prior to the thinning process of the semiconductor substrate 111, where the carrier 121 serves as a support during the thinning process. In some embodiments, a bonding layer (not shown, but similar to the bonding layer 118′ described in FIG. 8) is formed on the back side 111b′ of the semiconductor substrate 111′ for the back-side bonding process. It should be appreciated that although the structure shown in FIG. 4 is based on the structure of FIG. 3A to perform the aforementioned steps, the structure of FIG. 3B may undergo the similar steps (e.g., disposing the carrier 121 on the bonding layer 117 and optionally thinning the semiconductor substrate 111) to form the similar structure to be bonded.

Referring to FIG. 5 and with reference to FIG. 4 and FIG. 3B, a bonding process may be performed. In the illustrated embodiment, the structure in FIG. 4 serving as a second tier T2 and the structure in FIG. 3B serving as a first tier T1 are bonded together. Alternatively, the structure in FIG. 4 serving as a second tier T2 may be bonded to the structure in FIG. 3A serving as a first tier T1. The bonding may involve the wafer-to-wafer bonding, the die-to-wafer bonding, the die-to-die bonding or the like. In some embodiments where the die-to-wafer bonding or die-to-die bonding will be performed, the structure shown in FIG. 3B and/or FIG. 3A (or 4) may be singulated to form a plurality of dies before the bonding. In the illustrated embodiment, the bonding layer 117 of the first tier T1 is bonded to the semiconductor substrate 111′ of the second tier T2 through dielectric-to-semiconductor (e.g., oxide-to-silicon) bonding.

In some embodiments where the bonding layer (e.g., 118′ labeled in FIG. 8) is formed on the back side 111b′ of the semiconductor substrate 111′, the bonding of the first tier T1 and the second tier T2 include dielectric-to-dielectric (e.g., oxide-to-oxide) bonding. In some embodiments where the bonding layer (e.g., 118′ labeled in FIG. 8) on the back side 111b′ of the semiconductor substrate 111′ and the bonding layer 117 of the first tier T1 include metallic features, the bonding of the first tier T1 and the second tier T2 include metal-to-metal (e.g., copper-to-copper) bonding, dielectric-to-dielectric (e.g., oxide-to-oxide) bonding, and/or dielectric-to-metal (e.g., oxide-to-copper) bonding. Various bonding methods are within the contemplated scope of the present disclosure.

Referring to FIG. 6 and with reference to FIG. 5, the carrier 121 of the second tier T2 may be removed through any suitable removal process (e.g., grinding, etching, peeling, the like, a combination thereof, etc.). In some embodiments, a plurality of tiers is sequentially stacked upon and bonded to the second tier T2 using the bonding methods described in the preceding paragraphs to form a multi-tier bonded structure. The stacking/bonding process may continue until the stacked/bonded structure having desired number of tiers. For example, the bonded structure includes the first tier T1, the second tier T2 stacked upon and bonded to the first tier T1, and the topmost tier Tx stacked over the second tier T2. In alternative embodiments, the bonded structure is a two-tier structure which includes the topmost tier Tx and the first tier T1 (or the second tier T2) bonded together. The number of tiers may vary according to design requirements for the resulting semiconductor structure. In addition, although the topmost tier Tx is illustrated as the structure similar to FIG. 4, the thermal sensing devices 116 in the topmost tier Tx may be replaced with the thermal sensing devices 116 illustrated in FIG. 3B, in accordance with some embodiments.

In some embodiments, one or more through-tier via(s) 131 may be formed in the bonded structure to provide electrical interconnection between adjacent tiers. For example, the through-tier via 131 is formed by depositing one or more diffusion barrier layer(s) or isolation layer(s), depositing a seed layer, and depositing a conductive material (e.g., Cu, Ti, Ta, Al, alloy, any combinations thereof, and/or the like) into the trench of each tier. The respective through-tier via 131 may be a long via passing through multiple tiers and landing on the conductive pad of the interconnect structure 115 in the first tier T1 (or the tier above the first tier T1). In some embodiments, the through-tier via 131 is in lateral and electrical contact with the conductive layer 1152 of the interconnect structure 115 in the tiers (e.g., T2, Tx, and the tiers between T2 and Tx). In some other embodiments, the respective through-tier via 131 includes multiple segments, and the lowest segment may penetrate through the entire tier (e.g., the second tier T2) and extend into the upper portion of the underlying tier (e.g., the first tier T1) to land on the conductive pad of the interconnect structure 115 in the first tier T1, where the adjacent segments of the through-tier via 131 may be connected through conductive features (e.g., conductive pads or the like; not shown). The through-tier via 131 may be formed after the stacking/bonding process is finished. In some other embodiments, the through-tier via 131 is formed after two (or more) tiers are bonded together and before the additional tier is bonded thereon.

For the topmost tier Tx, the carrier 121 may be remained on the top (e.g., disposed on the bonding layer 117). The through-tier via 131 in the topmost tier Tx may not extend through the bonding layer 117. In some embodiments, one end of the through-tier via 131 in the topmost tier Tx is located within the interconnect structure 115 of the topmost tier Tx. For example, one end of the through-tier via 131 in the topmost tier Tx is in direct contact with the lower surface of the bonding layer 117. In some other embodiments, one end of the through-tier via 131 in the topmost tier Tx lands on the conductive pad (not individually shown) of the interconnect structure 115 of the topmost tier Tx.

Referring to FIG. 7 and with reference to FIG. 6, a plurality of conductive terminals 103 may be formed below the first tier T1. The conductive terminals 103 may include a conductive material such as solder, Cu, Al, Ag, Ni, Au, the like, or a combination thereof. The conductive terminals 103 may be or include ball grid array (BGA) connectors, solder balls, metal pillars, controlled collapse chip connection (C4) bumps, micro-bumps, electroless nickel-electroless palladium-immersion gold (ENEPIG) formed bumps, or the like. In some embodiments, before forming the conductive terminals 103, the semiconductor substrate 111 of the first tier T1 is thinned down to accessibly expose the through via 114 for further electrical connection. In some other embodiment where the through via 114 is not formed in the previous steps, the semiconductor substrate 111 of the first tier T1 is thinned down, and then the through via 114 is formed through the semiconductor substrate 111′. Since the through via 114 penetrates through the semiconductor substrate 111′, the through via 114 may be referred to as a through substrate via (TSV) 114 according to some embodiments.

In some embodiments, after the TSV 114 is exposed/formed, a redistribution structure 102 is formed on the back side 111b′ of the semiconductor substrate 111′ of the first tier T1. The redistribution structure 102 may include a dielectric layer 1021 and a conductive layer 1022 formed in/on the dielectric layer 1021 and electrically connected to the TSV 114. In some embodiments, the conductive terminals 103 are formed after the formation of the redistribution structure 102. For example, the conductive terminals 103 are formed on the conductive layer 1022 (e.g., under bump metallization (UBM) pads or the like) of the redistribution structure 102. It should be noted that the foregoing sequence merely serves as an illustrative example, and the disclosure is not limited thereto. In alternative embodiment where the TSV 114 is omitted, the conductive layer 1022 of the redistribution structure 102 may be in electrical and physical contact with the through-tier via 131. Other electrical path(s) may be formed in/on the bonded structure to provide an external electrical connection to the circuitry and devices of the resulting semiconductor structure.

In some embodiments, a heat-dissipating component 122 is disposed on the topmost tier Tx. The heat-dissipating component 122 may be formed from a material with high thermal conductivity, such as steel, stainless steel, copper, the like, combinations thereof, or any material having good thermal conductivity for heat spreading mechanism. In some embodiments, the heat-dissipating component 122 is coated with another metal. The heat-dissipating component 122 may be a single contiguous material or may include multiple pieces having the same or different materials. The heat-dissipating component 122 may be or include a heat sink, a heat spreader, a lid, etc. The heat-dissipating component 122 is given for illustrative purposes, and the heat-dissipating component 122 may be provided in any suitable form (e.g., a plate-form, a fin-form, etc.).

In some embodiments, the heat-dissipating component 122 is attached to the carrier 121 of the topmost tier Tx by an adhesive (not individually shown). The adhesive may be epoxy, glue, or the like, and may include a thermally conductive material or any material which is capable of transferring heat. The heat-dissipating component 122 may be thermally coupled to the underlying structure through the adhesive. The adhesive may be deposited at the intended location(s) to allow the heat-dissipating component 122 to be attached onto the carrier 121. Alternatively, the carrier 121 of the topmost tier Tx is omitted, and the heat-dissipating component 122 is directly bonded to the bonding layer 117 of the topmost tier Tx. In alternative embodiments, the heat-dissipating component 122 is omitted. It should be noted that the heat-dissipating component 122 may be any type of heat spreading mechanism which meets heat dissipation requirements of the resulting structure.

In some embodiments, a singulation process is performed to dice the bonded structure into a plurality of semiconductor structures 10A. The respective semiconductor structure 10A may then be packaged or coupled to another package component, depending on demands. In some embodiments, the heat-dissipating component 122 is coupled to the topmost tier Tx after the singulation such that the lateral dimension of the heat-dissipating component 122 is greater than the lateral dimension of the underlying singulated structure. In alternative embodiments, the lateral dimension of the heat-dissipating component 122 is substantially equal to or less than the lateral dimension of the underlying singulated structure.

FIG. 8 illustrates a schematic cross-sectional view of a semiconductor structure, in accordance with some embodiments. Like reference numerals denote like features with similar structures and compositions, unless otherwise excepted. Referring to FIG. 8 and with reference to FIG. 7, a semiconductor structure 10B shown in FIG. 8 may be similar to the semiconductor structure 10A shown in FIG. 7, and thus the detailed descriptions are not repeated for the sake of brevity. The difference therebetween lies in the bonding mechanism of the adjacent tiers and the omission of the through-tier via. For example, the front-side bonding layer 117′ of the first tier T1 includes a bonding dielectric layer 1171 and one or more bonding feature(s) 1172 laterally covered by the bonding dielectric layer 1171. The respective bonding feature 1172 may include one or more conductive material(s) such as Cu, Ti, Ta, alloy, the like, a combination thereof, etc. The respective bonding feature 1172 may be or include a conductive pad, a conductive via, and/or the like, and may be electrically connected to the underlying conductive layer 1152 of the interconnect structure 115. The bonding surfaces of the bonding dielectric layer 1171 and the bonding feature 1172 may be substantially leveled (or coplanar), within process variations.

The topmost Tx may include a backside bonding layer 118′ directly bonded to the front-side bonding layer 117′. The backside bonding layer 118′ of the topmost tier Tx may include a bonding dielectric layer 1181 and one or more bonding feature(s) 1182 laterally covered by the bonding dielectric layer 1181. In some embodiments, in the topmost tier Tx, the bonding feature 1182 is electrically coupled to the conductive layer 1152 of the interconnect structure 115 through the TSV 114. The bonding dielectric layer 1181 and the bonding feature 1182 may be similar to the bonding dielectric layer 1171 and the bonding feature 1172, respectively. The bonding surfaces of the bonding dielectric layer 1181 and the bonding feature 1182 may be substantially leveled (or coplanar), within process variations. The bonding dielectric layer 1181 may be bonded to the bonding dielectric layer 1171 through dielectric-to-dielectric (e.g., oxide-to-oxide) bonding. The bonding feature 1182 may be bonded to the bonding feature 1172 with a one-to-one correspondence through direct metal-to-metal (e.g., Cu-to-Cu) bonding. The bonding features (1172 and 1182) may be pad-to-pad bonding, via-to-via bonding, or via-to-pad bonding, depending on product requirements. In some embodiments, metal-to-dielectric (e.g., Cu-to-oxide) bonds may be formed at the bonding interface IF1 of the bonded tiers. The bonding interface IF1 may be substantially planar and/or flat.

In the illustrated embodiment, the topmost tier Tx is stacked upon and bonded to the first tier T1, where the backside bonding layer 118′ of the topmost tier Tx is directly bonded to the front-side bonding layer 117′ of the first tier T1. In some embodiments, one or more tier(s) may be interposed between the topmost tier Tx and the first tier T1 and may be bonded to the topmost tier Tx and the first tier T1 through the same/similar bonding mechanism. The bonding mechanism of the tiers in the semiconductor structure 10B may be viewed as a face-to-back bonding. In alternative embodiments, a face-to-face bonding (e.g., the front-side bonding layer 117′ of the upper tier is bonded to the front-side bonding layer 117′ of the lower tier) or back-to-back bonding (e.g., the backside bonding layer 118′ of the upper tier is bonded to the backside bonding layer 118′ of the lower tier) may be applied depending on product design. It should be appreciated that while the bonding mechanism has been described to connect the upper tier to the lower tier, alternative connection schemes are also possible, with corresponding adaptations to the bonding interface. In addition, the semiconductor structure 10B may have a different number of tiers and arrangement than shown.

FIG. 9 illustrates a schematic circuit diagram of a measurement circuit for a thermal sensor, in accordance with some embodiments. It should be noted that the circuit is but one illustrative circuit incorporating the embodiment methods, but is not limiting on the embodiments and the disclosure. In addition, the 3-omega (3ω) measurement method which is applicable to the measurement circuit is discussed below. For example, the on-chip measurement of the parameters (e.g., temperature, thermal conductivity, heat capacity, thermal diffusivity, etc.) may be obtained using the 30 measurement method.

Referring to FIG. 9 and with reference to FIG. 7 or FIG. 8, the measurement circuit 116M (or 116M′) applied in the thermal sensing device 116 may be formed in any tier of the semiconductor structure 10A/10B. The measurement circuit 116M (or 116M′) may be thermally and/or electrically coupled to the hot spots 10HS for temperature measurement. In some embodiments, the measurement circuit 116M (or 116M′) includes the metallization patterns 116S (e.g., resistive component) to provide the resistance RT, where the subscript “T” may represent “thermal”. The resistive component 116S may be coupled to an input voltage V_{1ω}, where the voltage V_{1ω} may be an oscillating (or sinusoidal) voltage signal with the frequency 1ω. When the voltage V_{1ω} is configured to excite the resistive component 116S at the frequency ω, the periodic heating generates oscillations in the resistance R_{T} of the resistive component 116S at a frequency of 2ω, which results in the heating part with a frequency of 3ω. In other words, the input current may heat up the resistive component 116S with the frequency of 2ω, which results in an oscillating temperature rise with the frequency of 2ω. Since the resistance R_{T} of the resistive component 116S linearly depends on the temperature, the voltage drops across the heating part occur and may have the frequency of 3ω which is used to estimate the magnitude of the temperature oscillation. The readout of the voltage V_{3ω} may have an amplitude calculated by Equation (1):

$${V}_{3 ω} = ( 1 / 2 ) {V}_{0} βΔ {T}_{oscill} \qquad ( 1 )$$

where in Equation (1), ΔT_{oscill} is the magnitude of the temperature oscillation, β is the thermal coefficient of resistance of the metallization patterns 116S, and V₀ is based on the resistance without periodic heating R₀ (V₀=I₀*R₀). The background temperature may be calculated from V₀ through pre-calibration.

Since Fourier's law is the basic law of thermal conductivity and thermal resistance is the inverse of thermal conductance, measuring V_{3ω} and solving Fourier's law for specific geometries, the local effective thermal resistance may be obtained. The on-chip measurement of the parameters (e.g., temperature, thermal conductivity, heat capacity, thermal diffusivity, etc.) may be obtained by using 3ω measurement and solving Fourier's law. In some embodiments, the output of the resistive component 116S is coupled to a filter 101. The measurement circuit 116M (or 116M′) may include an amplifier A1 coupled to the filter 101 and the circuit output terminal. The FEOL devices 116T (or the BEOL devices 116T′) may serve as the circuit output terminal. In some embodiments, some of the FEOL devices 116T (or the BEOL devices 116T′) are included in the amplifier A1. The filter 101 (e.g., a band-pass filter, Fourier transform circuit, etc.) may be applied in the measurement circuit 116M (or 116M′) for signal extraction.

In some embodiments, the filter 101 is implemented as a tunable band-pass filter which allows signals between a selected frequency ranges and blocks other signals having other frequency ranges. The band-pass filter may include a low-pass filter and a high-pass filter, where the high-pass filter passes high frequency signal and impedes low frequency signal, while the low-pass filter passes low frequency signal and impedes high frequency signal. In some embodiments, the capacitor C_{L} belongs to the low-pass filter and the capacitor C_{H} belongs to the high-pass filter, where the BEOL devices 116C labeled in FIG. 2A or FIG. 2B may serve as the capacitors C_{L} and C_{H}. In some embodiments, the capacitors C_{L} and C_{H} are connected to the FEOL devices 116T (and/or the BEOL devices 116T′), where the FEOL devices 116T (and/or the BEOL devices 116T′) are used to provide the resistance R_{S}, where the subscript “S” may represent “stabilize”. For example, the FEOL devices 116T (and/or the BEOL devices 116T′) may include stabilize resistance characteristics. In some embodiments, the transistor (not individually shown) included in the amplifier A1 provides the resistance to the high-pass filter section. In some embodiments, the positive input terminal of the amplifier A1 is coupled to the capacitor C_{H}, while the negative input terminal of the amplifier A1 is coupled to the capacitor C_{L}. The filter 101 may be configured to transmit a selected frequency signal and have some advantages such as saving energy, reducing noise, distortion, and complexity, etc.

By configuring the filter 101 in the measurement circuit 116M (or 116M′) for the 3ω signal extraction, a circuitry (e.g., a lock-in amplifier or the like) or external device(s) for signal extraction may be omitted from the measurement circuit 116M (or 116M′). The electro-thermal measurement circuit 116M (or 116M′) including a ring-oscillator for sinusoidal wave generation and the filter 101 (or Fourier transform circuit) for signal extraction is simple, and the measurement circuit 116M (or 116M′) may occupy a small area in the respective tier so as to save circuit area. The external equipment (e.g., current source) may also be omitted since the existing circuitry/devices in the semiconductor structure 10A/10B may be configured to provide the input voltage signal. The resistance of the thermal sensing devices 116 may be relatively small (e.g., few ohms) as the measurement accuracy only depends on the voltage supply and the filter/transform circuit. A relatively large resistor (e.g., 2˜10 times of the sensor resistance) may be used to stabilize the current and covert the voltage source, e.g. the voltage signal from the ring-oscillator, to the current source, which may be a part of the interconnect structure 115.

FIG. 10A illustrates a schematic top-down view of a layer of the interconnect structure in which the thermal sensors are located, and FIG. 10B illustrates a schematic cross-sectional view of a portion of the thermal sensors in the interconnect structure, in accordance with some embodiments. Referring to FIGS. 10A-10B and with reference to FIG. 9 and FIGS. 2A-2B, the metallization patterns 116S of the thermal sensing device 116 severing a heater and at the same time as a sensing element may be embedded in the dielectric layer 1151 of the interconnect structure 115. The interconnect structure 115 includes a plurality of conductive sublayers (namely M1, . . . , Mn), where n is an integer greater than or equal to 1. In some embodiments, the metallization patterns 116S are disposed alongside the conductive sublayer Mn, where n is an integer greater than or equal to 4. Alternatively, n is an integer greater than or equal to 1. The metallization patterns 116S may be close enough to the hot spots (e.g., 10HS labeled in FIGS. 7-8). The hot spots 10HS may be the region where the high-power devices are located or the region/path having thermal bottleneck. By arranging the metallization patterns 116S near specific/temperature-sensitive regions, temperature data may be better correlated to actual temperature at the hot spots 10HS. It should be appreciated that the number and the configuration of the metallization patterns 116S in the plane view of FIG. 10A are shown for illustrative purposes, and the metallization patterns 116S may have a different arrangement and number than shown.

With continued reference to FIGS. 10A-10B, the metallization patterns 116S and the conductive sublayers (Mn+1, Mn, and Mn−1) may be disposed at substantially the same level. As used herein, when the elements are described as “at substantially the same level”, the elements are formed at substantially the same height in the same layer. For example, the elements at substantially the same level are formed from the same/similar material(s) with the same/similar process step(s). In some embodiments, the metallization patterns 116S include a first portion 1161v for voltage measurement. In some embodiments, the metallization pattern 116S includes a second portion 1161c for connection of the oscillating current with the frequency of 1ω, and the oscillating current may heat up the metallization pattern with the characteristic frequency of 2ω. In some embodiments, the first portion 1161v and the second portion 1161c are conductive vias and may be disposed at two opposing sides (e.g., upper and lower sides) of the metal line of the metallization patterns 116S. It should be appreciated that the number and the configuration of the first and second portions in FIG. 10B are shown for illustrative purposes, and the first and second portions may have a different arrangement and number than shown.

The aforementioned features to implement the thermal sensing devices 116 are given for illustrative purposes. Thermal sensing devices 116 may have a feature varying according to its temperature, but various types of thermal sensing devices 116 are within the contemplated scope of the present disclosure. The thermal sensing devices 116 may be partially or fully embedded in the interconnect structure 115. The thermal sensing devices 116 may be arranged in a manner to create a temperature profile map of the resulting semiconductor structure 10A/10B. For example, the metallization patterns 116S of the thermal sensing devices 116 may be disposed at different levels in the interconnect structure 115 to monitor the temperatures at different depths in the respective tier, thereby creating the thermal profile mapping of the semiconductor structure 10A/10B.

Embodiments may have one or a combination of the following features and/or advantages. Embodiments of the thermal sensing devices 116 are embedded in one or more tier(s) of the semiconductor structure 10A/10B to monitor temperature of the hot spots 10HS on-chip and in real-time. The thermal sensing devices 116 arranged in the corresponding tier(s) may be configured to create thermal map across the semiconductor structure 10A/10B that enables control of the temperature of the integrated circuits. The measurement circuit 116M/116M′ applied in the thermal sensing device 116 may be integrated in semiconductor circuitry manufactured by FEOL processes, MEOL processes, BEOL processes, or any combination thereof. For example, the thermal sensing devices 116 formed of materials which are compatible with FEOL and/or BEOL processes make the transient electro-thermal sensing system to be easily integrated into the resulting structure. The transient electro-thermal measurement provides better accuracy of the measurement circuit, since the resistance measurement is accurate. The resistance of the thermal sensing devices 116 may be relatively small as the measurement accuracy depends on the voltage supply and the filter/transform circuit. The low resistance of the thermal sensing devices 116 may provide for efficient operation and reduced consumption of energy. By configuring the measurement circuit partially (or fully) in the interconnect structure 115, the circuit area/device footprint may be saved. The feedback circuit connected to the thermal sensing device 116 may be configured to dynamically control the temperature across the semiconductor structure 10A/10B. For example, making the adjustment to the circuit operation is made in response to the measured temperatures to reduce or avoid an overheating condition, thereby enhancing performance and reliability of the semiconductor structure 10A/10B.

According to some embodiments, a semiconductor structure includes a first interconnect structure disposed over a first semiconductor substrate and a thermal sensing device. The thermal sensing device includes a first transistor, a second transistor, a first capacitor coupled to the first transistor, a second capacitor coupled to the second transistor, and a metallization pattern embedded in the first interconnect structure and serving as a resistive heater. At least one selected from the group of the first and second transistors is embedded in the first interconnect structure.

According to some embodiments, a semiconductor structure includes an interconnect structure over a semiconductor substrate and a thermal sensing device. The thermal sensing device includes a resistive component embedded in the interconnect structure and a filter component coupled to the resistive component. The resistive component serves as a heater and the filter component allows signals between a selected frequency range, and the filter component includes a transistor and a capacitor connected to the transistor.

According to some embodiments, a manufacturing method of a semiconductor structure includes: forming devices on a semiconductor substrate through FEOL processes; forming an interconnect structure over the semiconductor substrate through BEOL processes; and forming a thermal sensing device, wherein the thermal sensing device are formed of materials compatible with at least one selected from the group of the FEOL processes and the BEOL processes.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor structure, comprising:
a first interconnect structure disposed over a first semiconductor substrate; and
a thermal sensing device comprising:
a first transistor and a second transistor, at least one selected from the group of the first and second transistors being embedded in the first interconnect structure;
a first capacitor and a second capacitor respectively coupled to the first transistor and the second transistor; and
a metallization pattern embedded in the first interconnect structure and serving as a resistive heater.

2. The semiconductor structure of claim 1, wherein the first and second transistors are embedded in the first interconnect structure.

3. The semiconductor structure of claim 1, wherein the first transistor is disposed over the first semiconductor substrate and underneath the first interconnect structure, and the second transistor is disposed over the first transistor and embedded in the first interconnect structure.

4. The semiconductor structure of claim 1, further comprising:
a first bonding layer disposed on a topmost layer of the first interconnect structure, wherein at least a portion of the metallization pattern is embedded in the topmost layer of the first interconnect structure.

5. The semiconductor structure of claim 4, further comprising:
a second interconnect structure disposed over a second semiconductor substrate, wherein the first bonding layer is bonded to the second semiconductor substrate.

6. The semiconductor structure of claim 5, further comprising:
a through via penetrating through the second interconnect structure, the second semiconductor substrate, and the first bonding layer to land on a conductive feature of the first interconnect structure.

7. The semiconductor structure of claim 4, further comprising:
a second interconnect structure disposed over a second semiconductor substrate; and
a second bonding layer disposed below the second semiconductor substrate and bonded to the first bonding layer.

8. The semiconductor structure of claim 7, wherein:
the first bonding layer comprises a first dielectric layer and a first bonding feature,
the second bonding layer comprises a second dielectric layer bonded to the first dielectric layer and a second bonding feature bonded to the first bonding feature, and
bonding surfaces of the first dielectric layer and the first bonding feature are substantially leveled.

9. The semiconductor structure of claim 4, further comprising:
a through via penetrating through the first interconnect structure and the first semiconductor substrate and landing on the first bonding layer.

10. The semiconductor structure of claim 1, wherein the metallization pattern is distributed at different levels of the first interconnect structure.

11. The semiconductor structure of claim 1, wherein the first transistor and the first capacitor are included in a low-pass filter, the second transistor and the second capacitor are included in a high-pass filter.

12. A semiconductor structure, comprising:
an interconnect structure over a semiconductor substrate; and
a thermal sensing device comprising:
a resistive component embedded in the interconnect structure and serving as a heater; and
a filter component coupled to the resistive component and allowing signals between a selected frequency range, the filter component comprising a transistor and a capacitor connected to the transistor.

13. The semiconductor structure of claim 12, wherein the transistor of the filter component is embedded in the interconnect structure.

14. The semiconductor structure of claim 12, further comprising:
a bonding layer disposed on a topmost layer of the interconnect structure, wherein at least a portion of the resistive component is embedded in the topmost layer of the interconnect structure.

15. The semiconductor structure of claim 14, wherein the bonding layer comprises a dielectric layer and a bonding feature, and bonding surfaces of the dielectric layer and the bonding feature are substantially leveled.

16. The semiconductor structure of claim 12, further comprising:
a through via penetrating through the interconnect structure and the semiconductor substrate.

17. A manufacturing method of a semiconductor structure, comprising:
forming devices on a semiconductor substrate through front-end-of-line (FEOL) processes;
forming an interconnect structure over the semiconductor substrate through back-end-of-line (BEOL) processes; and
forming a thermal sensing device, wherein the thermal sensing device are formed of materials compatible with at least one selected from the group of the FEOL processes and the BEOL processes.

18. The manufacturing method of claim 17, wherein forming the thermal sensing device comprises:
forming a transistor in the interconnect structure through the BEOL processes; and
forming a capacitor in the interconnect structure to be coupled to the transistor.

19. The manufacturing method of claim 17, wherein forming the thermal sensing device comprises:
forming a transistor through the FEOL processes when forming the devices; and
forming a metallization pattern in the interconnect structure to serve as a resistive heater.

20. The manufacturing method of claim 17, further comprising:
thinning the semiconductor substrate; and
forming a through via to penetrate through the interconnect structure and the semiconductor substrate after thinning the semiconductor substrate.
